(19) United States
(12) Patent Application Publication
(10) Pub. No.: US 2009/0200914 A1
(43) Pub. Date: Aug. 13, 2009

(54) Light emitting module

(75) Inventors: Gwo-Feng Hwang, Taipei City (TW); Yu-Shing Lien, Tucheng City (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: Bright View Electronics Co., Ltd.

(21) Appl. No.: 11/802,590

(22) Filed: May 23, 2007

(30) Foreign Application Priority Data
Nov. 2, 2006 (TW) 095140546

(51) Int. Cl. H01J 5/48; H01J 5/50

(52) U.S. Cl. 313/318.01

(57) ABSTRACT

The present invention relates to a light emitting module, which comprises: a main body; a common terminal, in which one side of the common terminal is exposed to the main body and a weldless coupling structure is disposed on the bottom of the common terminal; at least a control terminal, in which one side of the control terminal is exposed to the main body and a weldless coupling structure is disposed on the bottom of the control terminal; and at least a light emitting device. When assembling the components mentioned above, the common terminal and the control terminal are inserted into a through hole of a printed circuit board (PCB), such that the structure can be inlaid into the through hole and a better contact is obtained by its elasticity. Accordingly, the light emitting module can be fastened on the PCB.

### BACKGROUND OF THE INVENTION

1. Field of the Invention

The present invention is a subsequent application for ROC Patent No. 94117836 and relates to a light emitting module, and more particularly to a light emitting module in which a wireless coupling structure is disposed on the bottom of the terminals, such that the structure can be inlaid and fastened on a printed circuit board (PCB) and obtain a better contact by its elasticity.

2. Description of the Related Art

A general light emitting module, especially the one used in the multifunction OA (Office Automation) machines, generally uses soldering tin to solder the pins or terminals of the light emitting module to the through hole of the PCB, such that the structure can be fastened on the PCB. However, the foregoing connection method has the following disadvantages: 1. Since the welding temperature is pretty high, the shape of the plastic main body or the electronic part is easily damaged; 2. The manufacturing cost is inevitably increased by the welding process.

### SUMMARY OF THE INVENTION

Therefore, it is a primary objective of the present invention to provide a light emitting module that can be easily assembled so as to reduce the manufacturing cost.

It is another objective of the present invention to provide a light emitting module, in which the pins or terminals of the light emitting module are fastened on the PCB and a better contact can be obtained by using a weldless connection method. Wherein, the weldless connection method may be implemented by an elastic hook.

To achieve the foregoing objectives, the light emitting module of the present invention comprises: a main body, in which one side of the main body has a window; a common terminal, in which one side of the common terminal is placed inside the main body, the other side of the common terminal is exposed to the main body, and a weldless coupling structure is disposed on the bottom of the common terminal; at least a control terminal, in which one side of the control terminal is placed inside the main body, the other side of the control terminal is exposed to the main body, and a hook is disposed on the bottom of the control terminal; and at least a light emitting device that is placed in the window, in which one terminal of the light emitting device is coupled to the control terminal, and the other terminal of the light emitting device is coupled to the common terminal. When assembling the components mentioned above, the common terminal and the control terminal are inserted into a through hole of a printed circuit board (PCB), such that the structure can be inlaid into the through hole and obtain a better contact by its elasticity. Accordingly, the light emitting module can be fastened on the PCB.

### BRIEF DESCRIPTION DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 is a schematic decomposition diagram of a light emitting module according to a preferred embodiment of the present invention.

FIG. 2 is a schematic diagram showing the combination of a light emitting module and a PCB according to a preferred embodiment of the present invention.

FIG. 3 is a schematic decomposition diagram of a light emitting module according to another preferred embodiment of the present invention.

FIG. 4 is a schematic diagram showing the combination of the light emitting module and the PCB of FIG. 3.

FIG. 5 is a schematic diagram showing the light emitting module of the present invention further connecting to a light guide rod.

### DESCRIPTION PREFERRED EMBODIMENTS

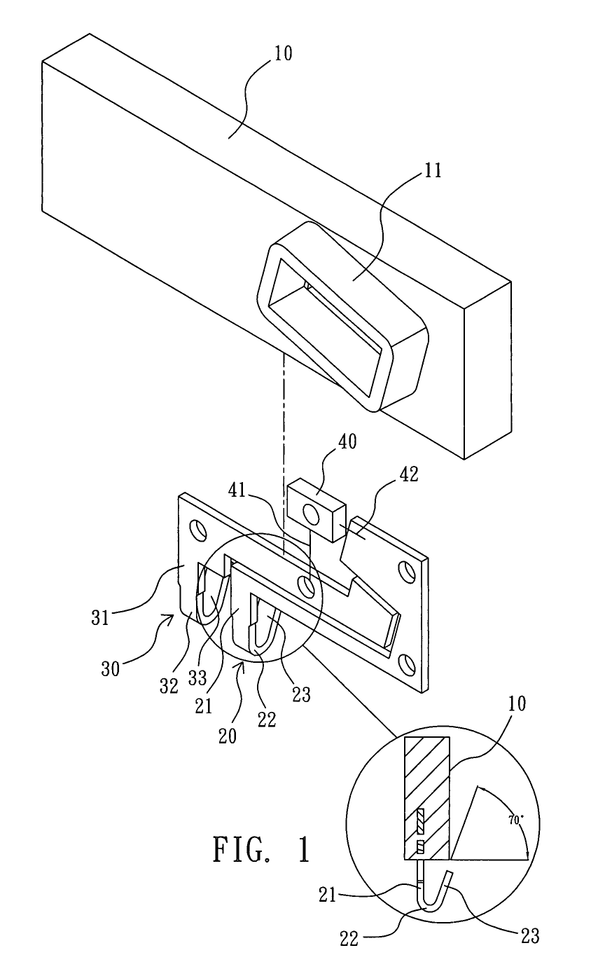

FIG. 1 is a schematic decomposition diagram of a light emitting module according to a preferred embodiment of the present invention. As shown in the drawing, the light emitting module of the present invention comprises a main body 10, a common terminal 20, a control terminal 30, and a light emitting device 40.

Wherein, the main body 10 is made of an insulation material, for example, it is made of a plastic material but not limited to it. One side of the main body 10 has a window 11, and the window 11 is for example, but not limited to be protruded or concaved on the main body 10. In the description of the present embodiment, the window 11 is protruded on the main body 10, but not limited to it. In addition, the window 10 is for example, but not limited to have a certain inclined angle.

One end 21 of the common terminal 20 is placed inside the main body 10, the other end 22 is exposed to the main body 10, and a weldless coupling structure 23 is disposed on the bottom of the common terminal 20. Here, the weldless coupling structure 23 is for example, but not limited to be a hook 23. In the present invention, the hook is exemplified for description, but not limited to it. The hook 23 is for example, but not limited to have an angle of 20°˜40°, and before the assembly, the extension line of its end is for example, but not limited to have a 70° inclined angle with the horizontal axis. In addition, the common terminal 20 is made of copper with a level higher than C5191H preferably, and the common terminal 20 is preferably a COM terminal.

One terminal 31 of the control terminal 30 is disposed inside the main body 10, the other terminal 32 is exposed to the main body 10, and a weldless coupling structure 33 is disposed on the bottom of the control terminal 30. The weldless coupling structure 33 is for example, but not limited to be a hook 33. The angle of the hook 33 is for example, but not limited to be 20°˜40°, and before the assembly, the extension line of its end is for example, but not limited to have a 70° inclined angle with the horizontal axis. The control terminal 30 is made of copper with a level higher than C5191H preferably. In addition, the common terminal 20 is placed inside the main body 10 but not contacted with the control terminal 30.

The light emitting device 40 is for example, but not limited to be a single color light emitting diode (LED). The light emitting device 40 is disposed in the window 11. An anode 41 of the light emitting device 40 is coupled to the control terminal 30, and an cathode 42 of the light emitting device 40 is coupled to the common terminal 20. Wherein, the main body 10, the common terminal 20, the control terminal 30, and the light emitting device 40 of the present invention are integrated into a single piece for reducing the manufacturing cost.

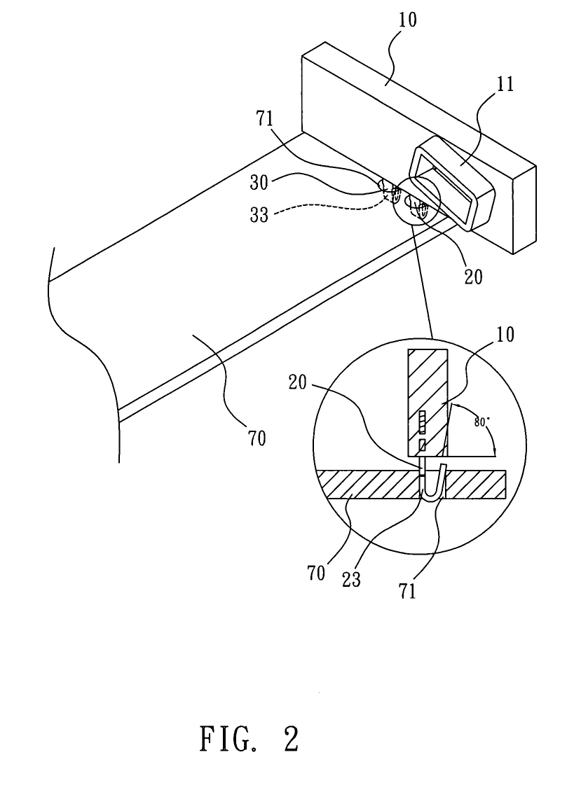

FIG. 2 is a schematic diagram showing the combination of a light emitting module and a PCB according to a preferred embodiment of the present invention. As shown in the drawing, when assembling the light emitting module of the present invention, the common terminal 20 and the control terminal 30 are inserted into a through hole 71 of a PCB 70. During the insertion, since the open angle of the hooks 23 and 33 is greater than the radius of the through hole 71, the hooks 23 and 33 are compressed, such that when the bottom of the hooks 23 and 33 pass through the through hole 71, the hooks 23 and 33 can be fully opened and clipped in the through hole 71 by its elasticity. Therefore, both ends of the hooks 23 and 33 can obtain a better contact with the through hole 71. Accordingly, the light emitting module can be fastened on the PCB 70 without using the welding process. In addition, when it is required to detach the light emitting module, the light emitting module can be easily detached from the PCB 70 by using a tool or finger to press on the open ends of the hooks 23 and 33 and pull up the light emitting module.

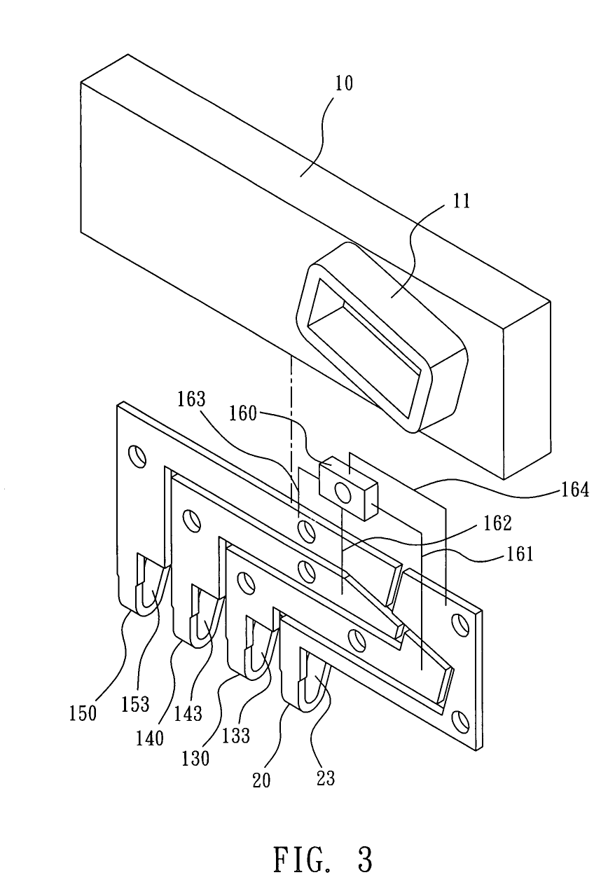

FIG. 3 is a schematic decomposition diagram of a light emitting module according to another preferred embodiment of the present invention. As shown in the drawing, the light emitting module of the present invention may have three control terminals, they are a first control terminal 130, a second control terminal 140, and a third control terminal 150. Wherein, the first control terminal 130, the second control terminal 140, and the third control terminal 150 have the hooks 133, 143, and 153 as shown in FIG. 1, respectively. The angle of the hooks 133, 143, and 153 is for example, but not limited to be 20°˜40°, and before the assembly, the extension line of its end is for example, but not limited to have a 70° inclined angle with the horizontal axis. In addition, the first control terminal 130, the second control terminal 140, and the third control terminal 150 are made of copper with a level higher than C5191H preferably, and the common terminal 20 is not contacted with the first control terminal 130, the second control terminal 140, and the third control terminal 150 in the main body 10.

The light emitting device 160 is a multicolor LED. In the present embodiment, a common anode LED is exemplified for description, but not limited to it. A first anode 161 of the light emitting device 160 is coupled to the first control terminal 130, a second anode 162 is coupled to the second control terminal 140, a third anode 163 is coupled to the third control terminal 150, and a cathode 164 is coupled to the common terminal 20. As mentioned above, the main body 10, the common terminal 20, the first control terminal 130, the second control terminal 140, the third control terminal 150, and the light emitting device 160 may be integrated into a single piece for reducing the manufacturing cost. Wherein, the first anode 161 and the cathode 164 can make the light emitting device 160 emit a red light, the second anode 162 and the cathode 164 can make the light emitting device 160 emit a green light, and the third anode 163 and the cathode 164 can make the light emitting device 160 emit a blue light.

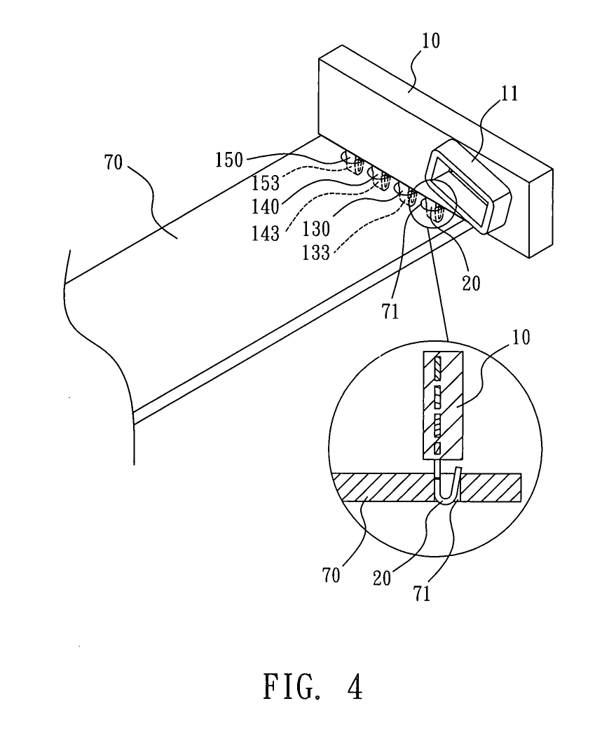

FIG. 4 is a schematic diagram showing the combination of the light emitting module and the PCB of FIG. 3. As shown in the drawing, when assembling the light emitting module of the present invention, the common terminal 20, the first control terminal 130, the second control terminal 140, and the third control terminal 150 are inserted into the through hole 71 of the PCB 70. During the insertion, since the open angle of the hooks 143, 144 and 145 is greater than the radius of the through hole 71, the hooks 143, 144 and 145 are compressed, such that when the bottom of the hooks 143, 144 and 145 pass through the through hole 71, the hooks 143, 144 and 145 can be fully opened and clipped in the through hole 71 by its elasticity. Therefore, both ends of the hooks 143, 144 and 145 can obtain a better contact with the through hole 71. Accordingly, the light emitting module can be fastened on the PCB 70 without using the welding process. In addition, when it is required to detach the light emitting module, the light emitting module can be easily detached from the PCB 70 by using a tool or finger to press on the open ends of the hooks 143, 144 and 145 and pull up the light emitting module. Accordingly, when comparing with the prior art, the light emitting module of the present invention has the advantage of reducing the manufacturing cost.

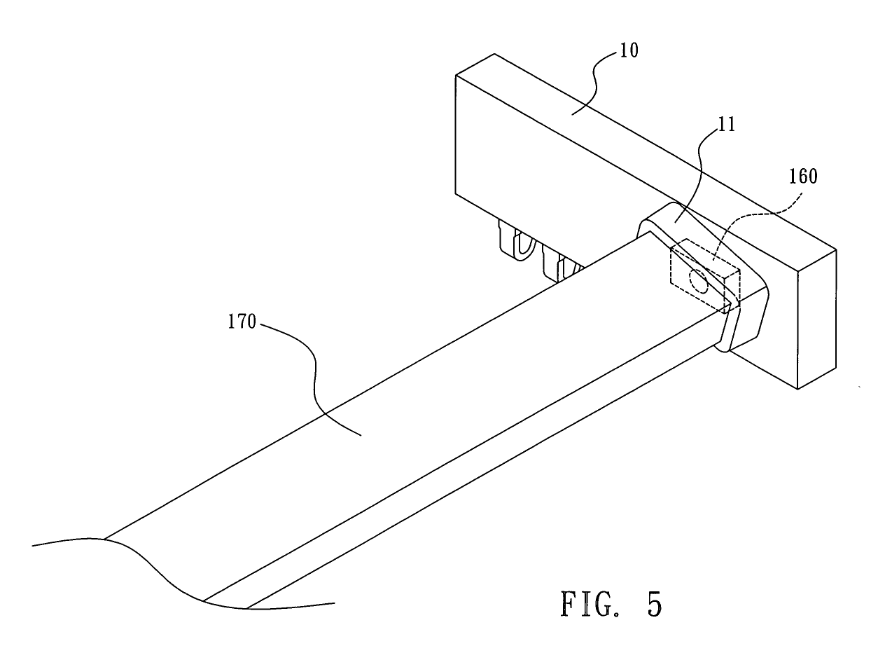

FIG. 5 is a schematic diagram showing the light emitting module of the present invention further connecting to a light guide rod. As shown in the drawing, the light emitting module of the present invention can further connect to a light guide rod 170. The light guide rod 170 is pulled-on or disposed inside the window 11 for guiding the light emitted by the light emitting device 40 or 160, such that the light can be used as the light source of the line scanning in the multifunction OA machine (not shown).

Therefore, the manufacturing cost of the light emitting module is effectively reduced in the present invention, such that the disadvantage of the conventional light emitting module is resolved.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A light emitting module, comprising:
a main body, wherein one side of said main body has a window;
a common terminal, having one terminal disposed in said main body and the other terminal exposed to said main body, wherein a weldless coupling structure is disposed on a bottom of said common terminal;
at least a control terminal, having one terminal disposed in said main body and the other terminal exposed to said main body, wherein a weldless coupling structure is disposed on a bottom of said control terminal; and
at least a light emitting device, being disposed in said window, having one terminal coupled to said control terminal and the other terminal coupled to said common terminal;
wherein, when assembling, said common terminal and said control terminal are inserted into a through hole of a printed circuit board (PCB), such that said weldless coupling structure can be inlaid into and clipped in said through hole and a better contact is obtained by an elasticity, accordingly said light emitting module can be fastened on said PCB.

2. The light emitting module of claim 1, wherein said weldless coupling structure is an elastic hook.

3. The light emitting module of claim 1, wherein said main body is made of an insulation material.

4. The light emitting module of claim 3, wherein said insulation material is a plastic material.

5. The light emitting module of claim 1, wherein said common terminal is a COM terminal, and there is one control terminal.

6. The light emitting module of claim 4, wherein said light emitting device is a single color light emitting diode (LED) having an anode coupled to said control terminal and a cathode coupled to said common terminal.

7. The light emitting module of claim 1, wherein said common terminal is a COM terminal, and there are three control terminals.

8. The light emitting module of claim 6, wherein said light emitting device is a multicolor light emitting diode (LED) having a first anode coupled to said first control terminal, a second anode coupled to said second control terminal, a third anode coupled to said third control terminal, and a cathode coupled to said common terminal.

9. The light emitting module of claim 8, wherein said first anode and said cathode emit a red light from said light emitting device, said second anode and said cathode emit a green light from said light emitting device, and said third anode and said cathode emit a blue light from said light emitting device.

10. The light emitting module of claim 1, wherein said common terminal and said control terminal are made of copper.

11. The light emitting module of claim 10, wherein the level of said copper is higher than C5191H.

12. The light emitting module of claim 1, wherein said hook has an angle of 20°˜40°.

13. The light emitting module of claim 1, wherein said main body, said common terminal, said control terminal, and said light emitting device are integrated into a single piece.

14. The light emitting module of claim 1, wherein said window is protruded or concaved on said main body.

15. The light emitting module of claim 1, further connecting a light guide rod, wherein said light guide rod is pulled-on or disposed inside said window for guiding a light emitted by said light emitting device.

16. The light emitting module of claim 1, wherein said common terminal is not contacted with said control terminal in said main body.
